(19) United States
(12) Patent Application Publication
(10) Pub. No.: US 2007/0120940 A1
(43) Pub. Date: May 31, 2007

(54) Image drum and method of manufacturing the same

(75) Inventors: Kyu Ho Shin, Seoul (KR); Soon Cheol Kweon, Seoul (KR); Kae Dong Back, Yongin-si (KR); Chang Seung Lee, Yongin-si (KR); Won Kyoung Choi, Suwon-si (KR); Ki Deok Bae, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/484,687

(22) Filed: Jul. 12, 2006

(30) Foreign Application Priority Data
Nov. 30, 2005 (KR) 10-2005-0115866

(51) Int. Cl. B41J 2/39

(52) U.S. Cl. 347/141

(57) ABSTRACT

An image drum, for selectively adsorbing a toner on the image drum so as to form an image in a printing apparatus, includes a hollow cylindrical drum body and an electrode member. The electrode member includes a flexible substrate adapted to surround an outer circumferential surface of the drum body; a plurality of ring-shaped electrodes formed circumferentially on a top surface of the flexible substrate so as to be electrically insulated from one another; and a control unit disposed on a bottom surface of the flexible substrate for independently applying a voltage to each of the ring-shaped electrodes. The electrode member is disposed on the outer circumferential surface of the drum body.

### CROSS-REFERENCE TO RELATED APPLICATIONS

This application claims the right of priority under 35 U.S.C. § 119(a)-(d) of Korean Patent Application No. 10-2005-0115866, filed on Nov. 30, 2005, in the Korean Intellectual Property Office, the disclosure of which is incorporated herein in its entirety by reference.

### BACKGROUND OF THE INVENTION

1. Field of the Invention

Apparatuses and methods consistent with the present invention relate to an image drum for use in a printing apparatus, and more particularly to an image drum and a method of manufacturing the image drum, in which an image drum including a ring conductor can be easily fabricated and associated manufacturing costs can be reduced.

2. Description of the Related Art

FIG. 1 is a schematic perspective view illustrating a conventional image-forming element according to the conventional art, and FIG. 2 is an enlarged cross-sectional view illustrating a portion of the circumferential wall of the image-forming element according to the conventional art. The image-forming element shown in FIGS. 1 and 2 is disclosed in U.S. Pat. No. 6,014,157 by reference.

Referring to FIGS. 1 and 2, the conventional image-forming element 10 comprises a hollow cylindrical drum body 12 which is made of metal, preferably aluminum or an aluminum alloy. A plurality of circumferentially extending electrodes 14 are formed on the outer circumferential surface of the drum body 12. These electrodes 14 are electrically insulated from one another and from the drum body 12 and are covered by a thin layer of dielectric material. The ring-shaped electrodes 14 may generally be designed variously depending on the desired resolution of the images to be formed, but are preferably provided densely over the whole length of the drum body 12 in such a fashion as to be arranged with a pitch of, for example, about 40 μm in order to realize a resolution of approximately 600 dpi.

An elongate-shaped control unit 16 is mounted inside of the hollow drum body 12 such that a terminal array 18 formed at a longitudinal edge of the control unit 16 adjoins the internal wall of the drum body 12. The control unit 16 is arranged for individually applying a suitably high voltage to each of the electrodes 14 via the terminal array 18 in accordance with the image formation. As shown in FIG. 2, the individual electrodes 14 are formed as grooves separated by adjacent insulating ridges 20 and are filled internally with electrically conductive material 32. Since the electrically conductive material 32 fills in a small-diameter hole 24 and a large-diameter hole 26, together constituting a through-hole 22, the electrodes 14 are electrically connected to zebra-strips 36 disposed at the inner wall surface of the drum body 12 via the through-hole 22. In this case, an anodized surface layer 34 is present at the outer circumferential surface of the drum body 12 and at the internal wall of the through-holes so as to electrically insulate the drum body 12 and the electrodes 14 from each other.

In order to manufacture the image-forming element 10, the cylindrical drum body 12 is provided. The grooves are cut into the outer circumferential surface of the drum body, for example, by means of a diamond chisel in such a fashion as to have a pitch of approximately 40 μm and a width of approximately 20 μm in order to form the electrodes 14. Alternatively, these grooves may be formed on the outer circumferential surface of the drum body by means of a laser beam or an electron beam.

In the next step, the large-diameter holes 26 are cut into the wall of the drum body 12 from the inside by, for example, a laser beam. The small-diameter holes 24 may also be formed with a laser beam, either from the inside or outside of the drum body, to thereby form the through-holes 22. After the through-holes 22 including the small-diameter holes 24 and the large-diameter holes 26 have been formed, the whole drum body 12 is anodized so as to form the insulating metal oxide layer 34 on the whole surface of the drum body. Thereafter, the electrically conductive material 32 fills in the grooves 14 and the through-holes 22. The outer or inner circumferential surface of the drum body 12 is cut to a predetermined depth through grinding so as to effectuate the electrodes 14 and electrical connection portions inside of the through-holes 22. An insulating layer is formed on the outer circumferential surface of the drum body 12 and the control unit 16 is disposed inside of the drum body 12 so as to complete the manufacture of the image-forming element 10.

As described above, in order to form the electrodes 14 on the outer circumferential surface of the drum body 12, the grooves are densely formed over the whole length of the drum body 12 using a precise cutting tool and the through-holes 22 must be formed at regular intervals either from the inside or outside of the drum body 12. Also, after the formation of the anodized surface layer on the outer circumferential surface of the drum body 12 and at the internal wall of the through-holes 22, the electrically conductive material 32 is filled into the grooves and the through-holes and is removed until a desired thickness of the drum body 12 remains. Specifically, since it is very difficult to evenly form the grooves on the outer circumferential surface of the drum body 12 in such a fashion as to have a pitch of approximately 40 μm and a width of approximately 20 μm and to fabricate the through-holes 22, the manufacturing cost of the image-forming element 10 is very high and a defects regularly occur. As mentioned above, there is at present a disclosed direct-induction-type, image-forming method and apparatus using a ring conductor such as the image-forming element as described above. However, the conventional image-forming method and apparatus entails a problem in that a printer made by using such a method and apparatus is high priced, which makes it difficult for the printer to be popularized.

### SUMMARY OF THE INVENTION

Accordingly, the present invention has been made in view of the aforementioned problems occurring in the conventional art. An exemplary embodiment of the present invention provides an image drum which can be easily fabricated and can enable an excellent quality of printing, and a method of manufacturing the image drum.

Another exemplary embodiment of the present invention provides an image drum which can be rapidly and easily fabricated, is advantageous for mass production, and can reduce manufacturing costs, and a method of manufacturing the image drum.

A further exemplary embodiment of the present invention provides an image drum which can effectively discharge heat generated in the image drum so that it can be utilized for a long time period without inconvenience.

To accomplish the above, according to one exemplary embodiment of the present invention, there is provided a image drum which has long-lasting, good heat conductive characteristics.

According to an exemplary embodiment of the present invention, the novel image drum includes a drum body and an electrode member. The electrode member includes a flexible substrate, ring-shaped electrodes for a ring conductor, and a control unit. The ring-shaped electrodes are formed on the flexible substrate and the control unit is joined to the flexible substrate. An image drum for selectively adsorbing a toner on the image drum so as to form an image in a printing apparatus may include, for example, a hollow cylindrical drum body and an electrode member. The electrode member may include a flexible substrate adapted to surround an outer circumferential surface of the drum body, a plurality of ring-shaped electrodes formed circumferentially on a top surface of the flexible substrate so as to be electrically insulated from one another, and a control unit disposed on a bottom surface of the flexible substrate for independently applying a voltage to each of the ring-shaped electrodes. The electrode member may be disposed on the outer circumferential surface of the drum body.

As mentioned above, a conventional image drum is constructed such that grooves are formed on the outer circumferential surface of the drum body by using a diamond cutting tool, etc., and an electrically conductive material is filled into the grooves so as to form ring-shaped conductors. Further, through-holes are formed in the drum body using a laser beam, etc., so as to electrically interconnect an inside and an outside of the drum body, and an electrically conductive material fills in the through-holes to form an electrical connection portion.

However, in the present invention, ring-shaped electrodes may be formed on the flexible substrate and the control unit may be joined to the flexible substrate to correspond to each of the ring-shaped electrodes so as to form the electrode member. Generally, a conventional flexible printed circuit board (“FPCB”) technology may be used, and it is possible to form a copper line having a width of approximately 20 μm in FPCB. Thus, in the electrode member of the present invention, a copper pattern having a pitch of approximately 40 μm and a width of approximately 20 μm may also be formed on the flexible substrate. An application-specific integrated circuit (“ASIC”) chip may be used as the control unit. In this case, a needed number of ASIC chips can be joined to the flexible substrate by means of bonding, for example. The electrode member including the ring-shaped electrodes and the control unit is disposed on the outer circumferential surface of the drum body so as to form an image drum.

### BRIEF DESCRIPTION OF THE DRAWINGS

The above and other features and advantages of the present invention will be apparent from the following detailed description of the exemplary embodiments of the invention in conjunction with the accompanying drawings, in which:

FIG. 1 is a schematic perspective view illustrating a conventional image-forming element according to a conventional art;

FIG. 2 is an enlarged cross-sectional view illustrating a portion of the circumferential wall of the image-forming element according to the conventional art;

FIG. 3 is a schematic cross-sectional view illustrating the inner construction of a printer using an image drum according to an exemplary embodiment of the present invention;

FIG. 4 is a partially enlarged perspective view illustrating the image drum shown in FIG. 3;

FIG. 5 is a partially enlarged side cross-sectional view illustrating the image drum shown in FIG. 3;

FIG. 6 is a partially enlarged perspective view illustrating a process of manufacturing the image drum shown in FIG. 3;

FIG. 7 is a perspective view illustrating an image drum according to an exemplary embodiment of the present invention;

FIG. 8 is a partially enlarged perspective view illustrating the image drum shown in FIG. 7; and

FIG. 9 is a graph illustrating the relationship between the power per one chip and the junction temperature of a chip when a gear module of FIG. 7 is employed.

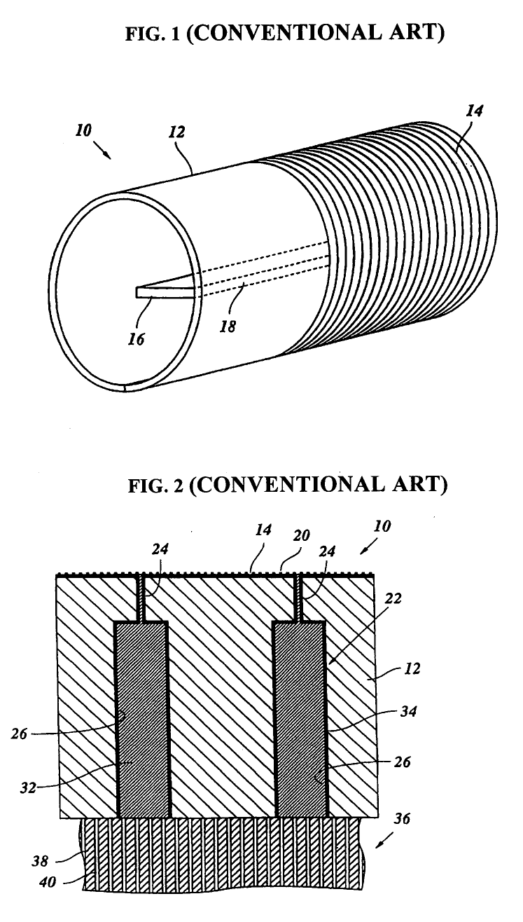

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The embodiments are described below in order to explain the present invention by referring to the figures.

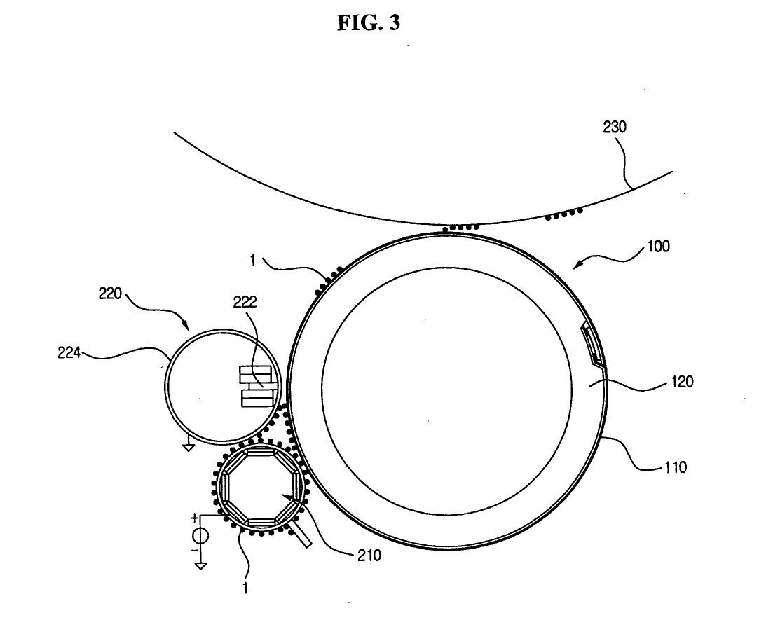

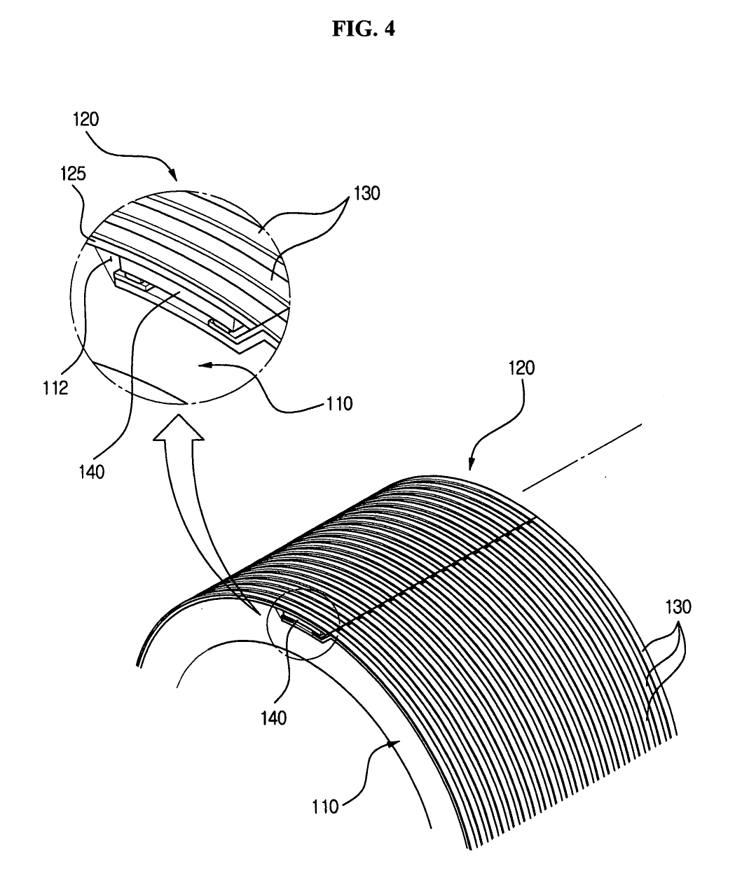

FIG. 3 is a schematic cross-sectional view illustrating the inner construction of a printer using an image drum 100 according to an exemplary embodiment of the present invention, and FIG. 4 is a partially enlarged perspective view illustrating the image drum 100 shown in FIG. 3.

Referring to FIGS. 3 and 4, the image drum 100 comprises a cylindrical drum body 110 and an electrode member 120. A toner feed roller 210, a magnetic cutter 220, and an image transfer section 230 are disposed around the outer circumferential surface of the image drum 100. A toner 1 from a toner storage section (not shown) is supplied to the toner feed roller 210 and is transferred to the image drum 100 from the toner feed roller 210 while moving on the outer circumferential surface of the toner feed roller 210. At this time, the toner is kept in an electrically charged state, and it is moved toward the magnetic cutter 220 while maintaining contact with an insulating layer formed on the outermost circumferential portion of the image drum 100.

The magnetic cutter 220 includes a rotary sleeve 224, and a magnet 222 disposed within the magnetic cutter 220 for applying an attractive magnetic force to the toner 1. The magnet 222 is positioned adjacent to the image drum 100, and can attract the toner 1 adhered to the surface of the image drum 100 using the magnetic force. The magnet 222 has a sufficient magnetic force so that it can collect the toner 1 from the electrodes of the image drum 100 that is not attracted to the image drum 100 by a voltage. The toner 1 collected by the magnet 222 is fed back to the toner storage section or the toner feed roller 210 via the rotary sleeve 224.

The toner 1 that is not fed back to the toner storage section or the toner feed roller 210 by the magnetic cutter 220 is transferred to the image transfer section 230 from the outer circumferential surface of the image drum 100. Then, the toner 1 transferred to the image transfer section 230 is moved to a printing paper sheet which is in turn heat-treated so as to allow the toner to be adhered to the surface of the printing paper sheet. To this end, the image drum 100 controls the voltage applied to the electrodes to conform to an image signal. Then, the image drum 100 generates a electrostatic force larger than the magnetic force of the magnet 222 so as to prevent the toner 1 from being collected to the magnetic cutter 220.

Approximately five thousand electrodes are controlled independently so as to represent a two dimensional image on the image drum 100. The image represented on the image drum 100 through the toner 1 can be transferred to the printing paper sheet by using the image transfer section 230 as a relay means. After the toner 1 has been adhered to the surface of the printing paper sheet, the printing paper sheet passes through a heat-treatment apparatus. At this time, the toner is adsorbed to the surface of the printing paper sheet to complete a corresponding printing.

As shown in FIGS. 3 and 4, the drum body 100 is formed in a hollow cylindrical shape, and may be formed of a material having excellent heat conductivity and mechanical strength. Also, an electrode member 120 including the flexible substrate 125 is provided on the outer circumferential surface of the drum body 110.

The electrode member 120 includes the flexible substrate 125, ring-shaped electrodes 130 formed on the top surface of the flexible substrate 125, and the control chip 140 formed beneath the bottom surface of the flexible substrate 125. The electrode member 120 may be formed of a thin insulating film made of a material such as polyimide, etc. Conductive patterns may be circumferentially formed on the outer circumferential surface of the flexible substrate 125. The conductive patterns are evenly formed as ring-shaped electrodes 130 in such a fashion as to have a pitch of approximately 40 μm and a width of approximately 20 μm. The ring-shaped electrodes 130 covering the circumference of the drum body 110 are formed to have a width corresponding to the printing width of the printing paper sheet. For example, assuming the printing paper sheet is of A4 size, the drum body 110 is formed to have a length of at least 20 cm to 22 cm over its whole width. At this time, each of the ring-shaped electrodes 130 may be formed to have a pitch of approximately 40 μm in order to achieve about five thousand lines. The ring-shaped electrodes can be formed in a ring structure which is closed as one piece or partially opened. That is, both ends of each of the ring-shaped electrodes 130 may be electrically interconnected to form a closed ring structure, but it is possible to electrically insulate both ends of the each ring-shaped electrode 130 according to circumstances.

Since the ring-shaped electrodes 130 can be formed by patterning copper or other thin conductive film in a flat state, a groove cutting step or a conductive material filling step employed in a conventional image drum manufacturing process can be eliminated in this exemplary embodiment. First of all, since it is possible to form the ring-shaped electrodes 130 on the planar flexible substrate 125, the level of work difficulty is greatly lowered as compared to a formation of the ring-shaped electrodes 130 on the outer circumferential surface of the cylindrical drum body 110, as well as remarkably reducing the generation rate of defective ring-shaped electrodes.

After the ring-shaped electrodes 130 have been formed on the flexible substrate 125, the control chip 140 can be joined to the bottom surface of the flexible substrate 125. The control chip 140 is connected to each ring-shaped electrode 130 on a one-to-one corresponding basis, and performs a kind of switch function so as to independently apply a necessary voltage to each electrode 130. The control chips 140 may be mounted at various positions, but in this exemplary embodiment are mounted abuttingly along one end edge of the flexible substrate 125. Owing to this arrangement of components, the present invention provides an advantageous structure for the manufacture of the image drum 100 since it is possible to eliminate interconnection of the control unit disposed inside of the cylindrical drum body 110 to the ring-shaped conductor disposed outside of the drum body 110 by through-holes, which causes problems in the conventional art.

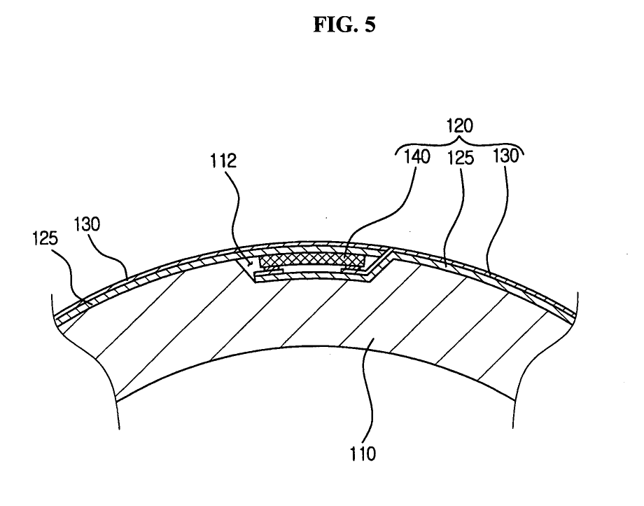

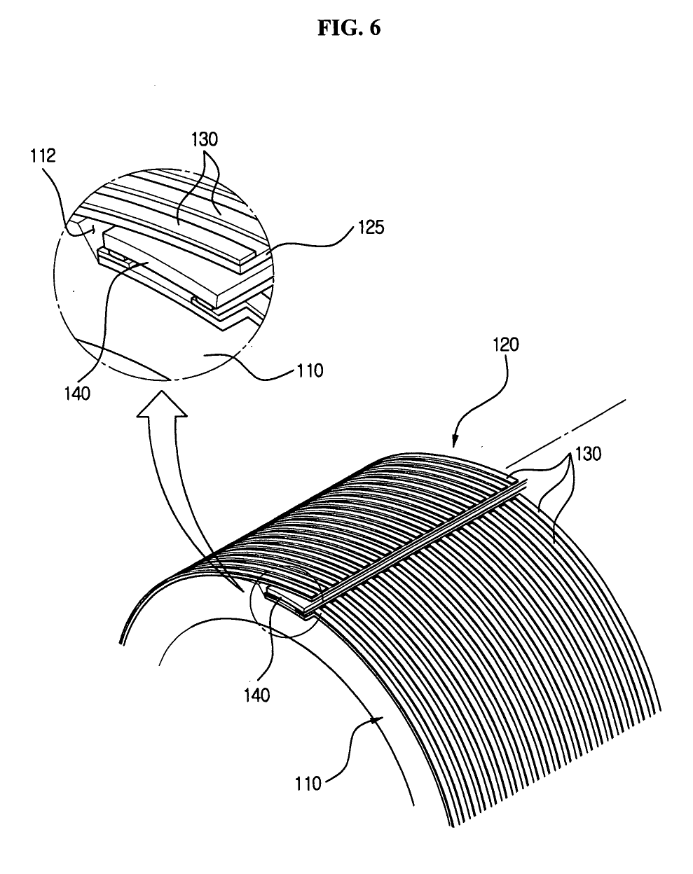

FIG. 5 is a partially enlarged side cross-sectional view illustrating the image drum 100 shown in FIG. 3, and FIG. 6 is a partially enlarged perspective view illustrating a process of manufacturing the image drum 100 shown in FIG. 3.

Referring to FIGS. 5 and 6, a recess 112 is longitudinally formed on the outer circumferential surface of the drum body 110. The recess 112 has a depth corresponding to a height of the control chip 140 and the flexible substrate 125, and is formed to have a width sufficient to accommodate the control chip therein. Therefore, a part of the electrode member 120 mounted with the control chip 140 is accommodated in the recess 112, and the other end of the electrode member 120 opposite to the control chip 140 covers over the recess. Thus, the whole surface of the image drum 100 is surrounded by the flexible substrate 125, and it can entirely cover the outer circumferential surface of the cylindrical drum body, although a partially overlapped portion exists.

As shown in FIG. 5, after one end of the flexible substrate 125 mounted with the control chip 140 has been disposed in the recess 112, the flexible substrate 125 surrounds the circumference of the drum body 110 and another end of flexible substrate 125 covers over the recess 112. At this time, a material of Epoxy Mold Compound (“EMC”), etc., may be used to fill an empty space defined between the control chip 140 and the flexible substrate 125.

In addition, as the control chip 140 is made thinner, it becomes more favorable for mounting on the flexible substrate 125. In additional, a thinner control chip 140 generally permits a slight bending of the control chip 140. To this end, the control chip 140 initially may be designed to be thin, and may be formed so as to have a thickness of about 20 μm to 30 μm by partially removing the bottom portion of a conventional ASIC chip.

Now, a manufacturing method of the image drum 100 will be described hereinafter.

First, in order to manufacture the image drum 100, the flexible substrate 125 formed with a plurality of ring-shaped electrodes 130 is fabricated. The flexible substrate 125 may be formed of polyimide material, and copper patterns may be formed on the surface of the flexible substrate 125 through a conventional photolithography, a screen printing, etc. The ring-shaped electrodes 130 are formed in a parallel linear shape on the surface of the flexible substrate 125 in such a fashion as to be regularly arranged while maintaining a width of approximately 20 μm prior to attachment of the flexible substrate 125 on the drum body 110.

After provision of the flexible substrate 125 formed with the ring-shaped electrodes 130, the control chip 140, embodied as an ASIC chip, is joined to the bottom surface of the flexible substrate 125 along one end edge of the flexible substrate 125. The control chip 140 is intended to independently apply a voltage to each of the ring-shaped electrodes 130, and can be electrically connected to the ring-shaped electrodes 130 by means of general die bonding, soldering, or the like.

Generally, an insulating layer is formed on the flexible substrate 125 and the ring-shaped electrodes 130. The insulating layer may be formed of a dielectric material such as, for example, Aluminum Nitride (“AlN”), Al₂O₃, etc. The ring-shaped electrodes 130 can be electrically insulated from one another by the insulating layer. The insulating layer may be formed on the flexible substrate 125 before and/or after the control chip 140 is joined to the flexible substrate 125.

After the ring-shaped electrodes 130 and the control chip 140 have been integrally formed on the flexible substrate 125, the flexible substrate 125 is attached on the outer circumferential surface of the hollow cylindrical drum body 110. At this time, a recess is formed on the outer circumferential surface of the drum body 110 to receive the control chip therein. Also, although the control chip 140 and the flexible substrate 125 are overlapped with each other in a vertical direction, it is possible to prevent any portion from projecting abnormally from the surface of the image drum.

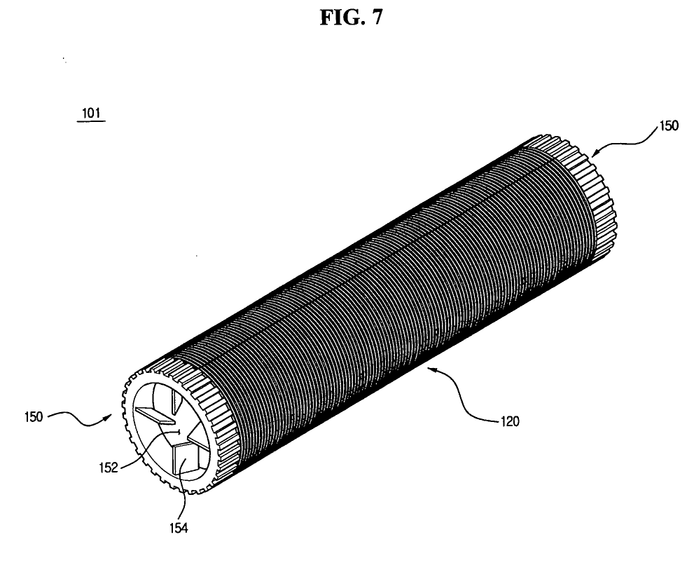

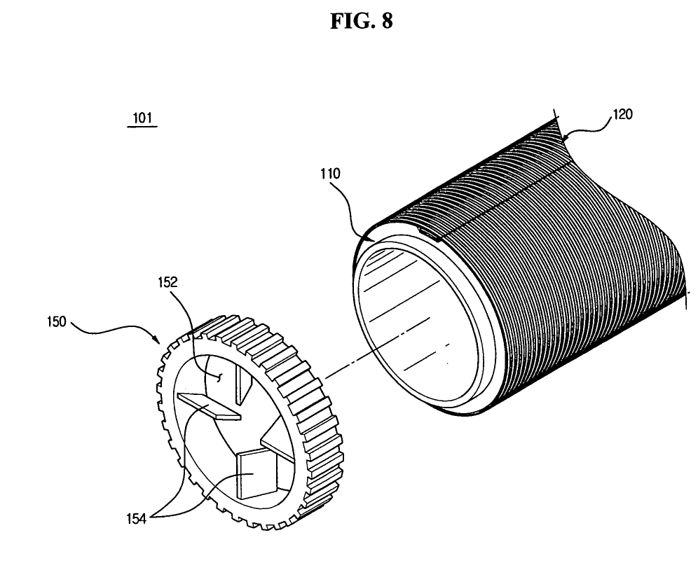

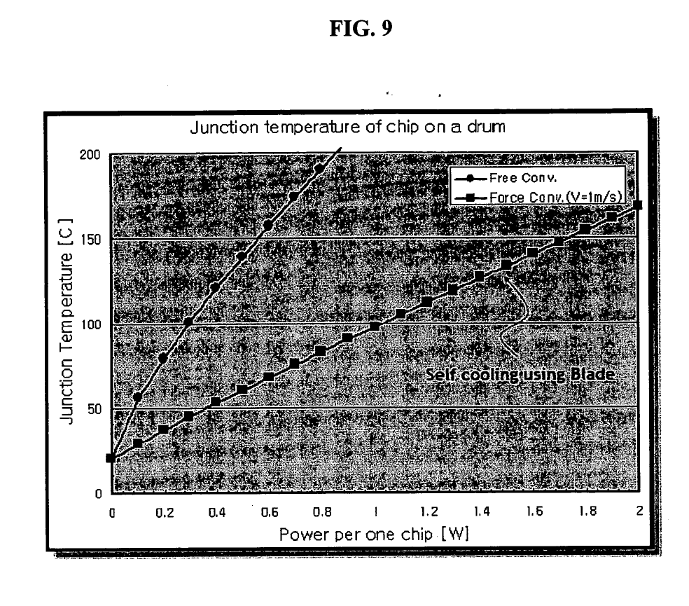

FIG. 7 is a perspective view illustrating an image drum according to an exemplary embodiment of the present invention, and FIG. 8 is a partially enlarged perspective view illustrating the image drum shown in FIG. 7.

Referring to FIGS. 7 and 8, after the flexible substrate 125 has been attached to the drum body 110, a gear module 150 is mounted to both ends of the drum body 110. The gear module 150 is intended to rotate the image drum. Gear teeth are formed on the outer circumferential surface of the gear module 150 so that the gear module can be functionally connected to an external gear motor drive and can be transmitted with a power necessary for the rotation of the image drum. The gear module 150 may be mounted to either one side or both sides of the drum body 110.

The gear module 150 is centrally formed with a through-hole 152 for allowing the inside and outside of the drum body 110 to be exposed to air. According to this exemplary embodiment, since the control chip 140 is covered by the flexible substrate 125 and the heat-conductivity of polyimide material forming the flexible substrate 125 is relatively poor, heat accumulation phenomenon may occur within the image drum 101. Of course, the drum body 110 is formed of aluminum having good heat-conductivity, but even though the inside of the drum body also is opened at both sides, heat may not be smoothly discharged to the outside.

Therefore, a plurality of blades 154 is radially formed inwardly from the through-hole 152 to improve smooth inflow or outflow of air. In order to rotate the image drum, the gear module must be rotated. At this time, a force may be generated for causing air flow from the blades 154 because of this rotation. By using a structural modification of forming the blades 154 integrally with one another, a forcible flow of air can be induced without power specifically allocated for air flow. In addition, since the structure of the blades is simple and a conventional connection structure can be used as is, it is not difficult to apply the blades to the novel image drum.

FIG. 9 is a graph illustrating the relationship between the power per one chip and the junction temperature of the chip when the gear module of FIG. 7 is employed.

Referring to FIG. 9, there are shown respective cases of the gear module including and not including the blades. In the case of not using the blades, almost no flow of air is generated. In this situation, it can be seen that the temperature of the control chip sharply increases as time elapses. On the other hand, in the case of using the blades, it can be seen that an air flow of about 1 m/s is generated and the temperature of the control chip increases relatively slowly as time elapses. As a result, although a separate cooling fan is not used, generation of heat from the image drum can be relieved.

The image drum of the present invention can easily be manufactured in such a fashion that the control chip is joined to the flexible substrate by forming the FPCB, and the integrally formed FPCB is surrounded on the drum body. Since it is possible the electrodes, which are easily manufactured, have a reduced generation rate of defects and have relatively excellent quality, a superior printing quality can be expected.

In addition, manufacturing of the image drum can be rapidly performed due to its structural simplicity, and the image drum is very favorable for mass production due to easy facilitation of each manufacturing step. Since it is possible to utilize a processing technology which is conventionally well known in the art, the manufacturing cost is reduced and the product cost can be lowered accordingly.

Moreover, because blades are formed at the gear module so as to effectively discharge heat generated from the control chip to the outside, the image drum can be used for a long period without fault or inconvenience.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An image drum for selectively adsorbing a toner on the image drum so as to form an image in a printing apparatus, the image drum comprising:
a hollow cylindrical drum body; and
an electrode member;
wherein the electrode member comprises:
a flexible substrate adapted to surround an outer circumferential surface of the drum body;
a plurality of ring-shaped electrodes formed circumferentially on a top surface of the flexible substrate so as to be electrically insulated from one another; and
a control unit disposed on a bottom surface of the flexible substrate for independently applying a voltage to each of the ring-shaped electrodes; and
wherein the electrode member is disposed on the outer circumferential surface of the drum body.

2. The image drum of claim 1, wherein the drum body comprises a recess longitudinally formed on the outer circumferential surface of the drum body to accommodate a portion of the electrode member mounted with the control unit, and
wherein an end of the flexible substrate opposite the control unit covers a portion of the accommodated control unit so as to maintain contact with the outer circumferential surface of the drum body.

3. The image drum of claim 2, wherein the control unit comprises a plurality of control chips abuttingly arranged along one end of the flexible substrate, and
wherein the recess is formed on the outer circumferential surface of the drum body in a longitudinal direction of the drum body to accommodate the control chips in the recess.

4. The image drum of claim 1, further comprising:
a gear module mounted on both ends of the drum body;
wherein the gear module comprises:
gear teeth;
a through-hole formed at a center of the gear module so as to be open to an inside of the drum body; and
a plurality of blades formed radially inwardly from the through-hole so that external air is introduced into the drum body by the blades when the drum body rotates.

5. An image drum for selectively adsorbing a toner on the image drum so as to form an image in a printing apparatus the image drum comprising:
a hollow cylindrical drum body comprising a recess longitudinally formed on an outer circumferential surface of the drum body; and
an electrode member;
wherein the electrode member comprises:
a flexible substrate adapted to surround the outer circumferential surface of the drum body;
a plurality of ring-shaped electrodes formed circumferentially on a top surface of the flexible substrate so as to be electrically insulated from one another; and
a plurality of control chips abuttingly arranged along one end of the flexible substrate for independently applying a voltage to each of the ring-shaped electrodes;
wherein a portion of the electrode member formed with the control chips is accommodated in the recess, and
wherein the flexible substrate formed with the ring-shaped electrodes covers the portion of the accommodated control chips so as to maintain contact with the outer circumferential surface of the drum body.

6. The image drum of claim 5, wherein the plurality of control chips are sufficiently thin so as to be able to be bent to come into close contact with a bottom surface of the flexible substrate along an outer extent of the recess.

7. The image drum of claim 5, further comprising:
a gear module mounted to both ends of the drum body;
wherein the gear module comprises:
gear teeth;
a through-hole formed at a center of the gear module so as to be open to an inside of the drum body; and
a plurality of blades formed radially inwardly from the through-hole so that external air is introduced into the drum body by the blades when the drum body rotates.

8. A method of manufacturing an image drum for selectively adsorbing a toner on the image drum so as to form an image in a printing apparatus, the method comprising:
providing a flexible substrate formed with a plurality of ring-shaped electrodes that are electrically insulated from one another and are arranged in parallel with one another;
joining a control unit to the flexible substrate so as to independently apply a voltage to each of the ring-shaped electrodes; and
attaching the flexible substrate and the control unit on an outer circumferential surface of a hollow cylindrical drum body.

9. The method of claim 8, wherein the drum body comprises a recess longitudinally formed on the outer circumferential surface of the drum body to accommodate the control unit, and
wherein the flexible substrate is attached on the outer circumferential surface of the drum body so that the control unit is correspondingly positioned in the recess.

10. The method of claim 9, wherein the control unit comprises a plurality of control chips abuttingly arranged along one end of the flexible substrate,
wherein the recess is linearly formed on the outer circumferential surface of the drum body in a longitudinal direction of the drum body to accommodate the control chips in the recess,
wherein a part of the flexible substrate joined to the control unit is positioned in the recess, and
wherein the flexible substrate is attached to the outer circumferential surface of the drum body so that another end of the flexible substrate opposite to the control chips covers the recess.

11. The method of claim 8, wherein a gear module is provided to be mounted to both ends of the drum body, and
wherein the gear module comprises:
gear teeth;
a through-hole formed at a center of the gear module so as to be open to an inside of the drum body; and
a plurality of blades formed radially inwardly from the through-hole so that external air is introduced into the drum body by the blades when the drum body rotates.
